(19) United States
(12) Patent Application Publication
(10) Pub. No.: US 2026/0179458 A1
(43) Pub. Date: Jun. 25, 2026

(54) MULTIPLE VENUE/CHANNEL VIDEO LOTTERY TERMINAL TOURNAMENTS

(71) Applicant: IGT, Las Vegas, NV (US)

(72) Inventors: Robert WALKER, Wakefield, RI (US); Todd GRIMM, Riverview (CA); Karen VAN NIEKERK, Dieppe (CA)

(73) Assignee: IGT, Las Vegas, NV (US)

(21) Appl. No.: 18/988,450

(22) Filed: Dec. 19, 2024

(51) Int. Cl. G07F 17/32

(52) U.S. Cl. CPC G07F 17/3276; G07F 17/323; G07F 17/3244

(57) ABSTRACT

A system includes a processor circuit and a memory comprising machine-readable instructions that, when executed by the processor circuit, cause the processor circuit to provide a tournament venue for a wagering game tournament to be played, and receive multiple tournament entries from multiple players for the wagering game tournament. For ones of the multiple of tournament entries, operations include receiving a tournament initiation instruction from one of the players at a video lottery tournament (VLT) gaming device, receive VLT game data for a base wagering game from the VLT gaming device during the wagering game tournament, determine a tournament score for the players in the tournament venue based on play data and a tournament parameter, evaluate multiple scores for the of players, and award a tournament prize to a player of the players based on an evaluation of the tournament scores corresponding to the wagering game tournament.

### BACKGROUND

Slot tournaments are an effective way of driving interest for a particular game or promotion in the casino space. However, operators may face challenges to engage similar mechanisms in the contest of video lottery terminals (VLTs). Thus, a need for a mechanism for running VLT's may be needed.

### BRIEF SUMMARY

According to some embodiments, a system includes a processor circuit and a memory coupled to the processor circuit. The memory includes machine-readable instructions that, when executed by the processor circuit, cause the processor circuit to provide a tournament venue for a wagering game tournament to be played, receive multiple tournament entries from multiple players for the wagering game tournament, for ones of the tournament entries, receive a tournament initiation instruction from one of the players at a video lottery tournament (VLT) gaming device, and receive VLT game data for a base wagering game from the VLT gaming device during the wagering game tournament. The processor circuit is further caused to determine a tournament score for the players in the tournament venue based on play data and a tournament parameter, evaluate multiple tournament scores for the players, and award a tournament prize to a player of the multiple players based on an evaluation of the tournament scores corresponding to the wagering game tournament.

According to some embodiments, a tournament controller includes a communication interface in communication with a plurality of gaming devices, a processor circuit, and a memory coupled to the processor circuit. The memory includes machine-readable instructions that, when executed by the processor circuit, cause the processor circuit to determine a tournament time period for a wagering game tournament and receive, via the communication interface, multiple tournament entries from the gaming devices during the tournament time period. Each tournament entry of the tournament entries may be associated with a player. Each tournament entry may receive, via the communication interface, a tournament initiation instruction from a gaming device of the gaming devices and receive, via the communication interface, game play data from the gaming device of the gaming devices for a base wagering game being played by the player at the gaming device during the wagering game tournament and that is determined to be played for a given quantity of spins.

According to some embodiments, a method performs operations of determining, by a processor circuit, a tournament time period for a wagering game tournament and that comprises multiple tournament starts times for different ones of multiple players, and receiving, by the processor circuit, multiple tournament entries from multiple video lottery tournament (VLT) gaming devices during the tournament time period. Each tournament entry of the tournament entries is associated with one of the players. Operations include, for each tournament entry, receiving, by the processor circuit, a tournament initiation instruction from the VLT gaming device of the VLT gaming devices, receiving, by the processor circuit, game play data from the gaming device of the VLT gaming devices for a base wagering game being played by the player at the gaming device during the tournament time period, and determining, by the processor circuit, a tournament score for the player associated with the gaming device based on play data and a tournament parameter. Operations may further include evaluating, by the processor circuit, multiple tournament scores for the players. Some embodiments provide that the game play data for the base wagering game is generated by each gaming device independently of the tournament parameter.

### BRIEF DESCRIPTION OF SEVERAL VIEWS OF THE DRAWINGS

FIG. 1 is a schematic block diagram illustrating a network configuration for a plurality of gaming devices according to some embodiments.

FIG. 2A is a perspective view of a gaming device that can be configured according to some embodiments.

FIG. 2B is a schematic block diagram illustrating an electronic configuration for a gaming device according to some embodiments.

FIG. 2C is a schematic block diagram that illustrates various functional modules of a gaming device according to some embodiments.

FIG. 2D is a perspective view of a gaming device that can be configured according to some embodiments.

FIG. 2E is a perspective view of a gaming device according to further embodiments.

FIG. 3 is a flowchart illustrating operations of systems/methods of providing multiple venue/channel video lottery tournaments, according to some embodiments.

FIG. 4 is a flowchart illustrating operations of systems/methods of providing multiple venue/channel video lottery tournaments, according to some embodiments.

FIG. 5 is a flowchart illustrating operations of systems/methods of providing multiple venue/channel video lottery tournaments, according to some embodiments.

### DETAILED DESCRIPTION

Embodiments described herein relate to wagering game tournaments, and in particular to wagering game tournament for distributed gaming device networks, and related devices, systems, and methods.

Wagering game tournaments may enhance wagering game play by offering the excitement of competitive play and a chance to win a tournament prize, which may be larger than typical prizes provided for base wagering games, such as conventional slot-style wagering games. In some examples, tournaments may be provided in a casino environment, e.g., at a plurality of Electronic Gaming Machines (EGMs), with the tournament game replacing the base wagering game during tournament play. One disadvantage of this arrangement is that changing the game or aspects of the game, such as game level, may trigger separate legal and/or regulatory compliance requirements. In some embodiments, a tournament may use data collected during play of the base wagering game without any changes to the base wagering game or game play. By using data collected from the EGM, Video Lottery Terminal (VLT) or other device while decoupling the wagering game tournament from the gameplay of the base wagering game, a unique technical solution to this technical problem may be provided.

In some examples, cash and non-cash tournaments may be provided. Tournaments may include walk-up tournaments and fixed-session tournaments. In some examples, players may be able to access and initiate tournament play through different types of gaming and/or computing devices, such as EGMs, VLTs, mobile and/or desktop computing devices, etc. For example, a player may be able to access tournament information via a mobile application connected to the player's loyalty account. In some examples, the tournament may be associated with certain game criteria, such as certain game themes, pay tables, denominations, etc., which may equalize the chances of winning for the participating players.

In some examples, a cash tournament may be provided. For example, a player may log into a player loyalty account, and a message may be displayed with information regarding a tournament being offered for certain games, during a certain tournament time period (e.g., with a start date and time, duration, end date and time), at certain locations, and/or with certain prizes, etc. The player may opt into the tournament and select a base wagering game (e.g., one or more of the games that is already available for play) as the tournament game(s).

During the tournament, the game play and experience of the base wagering game may be identical to the play and experience of the game in a non-tournament mode. The player may use cash, credits, reward points, etc. to pay for wagers normally, with the same denominations and paytables as normal. In some examples, a leaderboard may be displayed at the gaming device (e.g., on a display of or associate with the gaming device). For example, the leaderboard may display the top players in the whole network and/or in a selected areas, and may be updated in real time and/or periodically. The leaderboard may display a first and/or last name of the player, a player username, a player location, and/or a current point total, etc. for the top players.

In some examples, the player may be able to view their current point total, their current ranking, and/or a countdown clock showing how much time is remaining in the tournament and/or segment thereof. The leaderboard may also display similar information for players with similar point totals to the current player, in conjunction with or separate from the top player leaderboard information. Other displayed information may include the player's highest point total in previous tournaments.

In some examples, the player can participate in the tournament one single time or multiple times, in some configurations. For example, the tournament may be divided into time segments (e.g., 5 minutes), where the highest score achieved by a player in a particular 5-minute interval is their final score. The time interval may be non-rolling, i.e., with a set start time and end time, or rolling, i.e., beginning when the player initiates play of the tournament. In some examples, the tournament may be played in a single session, with all players eligible to play during the entire tournament time period.

In some examples, at the conclusion of the tournament time period, all point totals are compiled and a winner is determined. The winner may be notified directly and/or may be announced. For example, the winner may be announced at the winner's VLT in a full screen display and at other VLTs or devices (e.g., full screen at idle VLTs and in an information window in the VLTs being played by non-winners and/or non-participants. The award may be provided to the player in a variety of ways, such as by a deposit of player points to the winner's player loyalty account, a monetary

In some examples, a non-cash tournament may be provided. In some examples, a player at a VLT or other gaming device may be presented with a message containing tournament information. To take part in the tournament, a player may initiate a tournament entry via the VLT interface. In some examples, registered and/or unregistered players may be eligible to participate, as desired. One advantage of allowing unregistered players to participate is that new players may be attracted to the tournament without a registration requirement as a barrier to entry. In some examples, award of a tournament prize may include a registration component, which may serve as an incentive for unregistered participants to register to collect their winnings.

In some examples, the VLT or other gaming device may change to a non-cash configuration, e.g., disabling a bill/ticket validator at the VLT and/or disabling cashless transfers between the VLT and the player's cashless wallet, etc. A non-cashable amount of credit, e.g., $1,000 in free play credits) may be transferred from a tournament pool and/or credit budget to the VLT. After the player initiates the tournament entry, the tournament session begins and the player may play one or more tournament games for the tournament time period and/or a tournament segment (e.g., for 5 minutes). At the conclusion of the tournament time period and/or segment, a current credit balance is recorded for each player and the player with the highest total is identified as the winner. The winner's VLT may revert to a cash configuration, and the player can collect his prize through regular cash-out and/or transfer of funds to the player's cashless wallet, etc. In some examples, a temporary cashless account may be created for a winner that is not registered and/or does not have an existing cashless account. In some examples, the unregistered player may convert the temporary account to a full account by completing registration.

In some examples, players across all channels may be eligible to participate in one global tournament session at the same time. With real-time communication across devices and channels, synchronized updates of the leaderboard and other player-specific tournament information may be provided. In some examples, a count-down clock may be provided to indicate the start time of the tournament, so that the player can initiate participation as close to the start time as possible, thereby maximizing his opportunities to accumulate points.

In some examples, winning criteria for the tournament may include one or more of the following: amount wagered, number of games won and/or lost, consecutive games won and/or lost, amount won and/or lost, wins that meet a predetermined threshold, and/or other wagering game achievements, which may be customized by the operator and/or game provider, as desired. These and other variables may be weighted in a combined formula to generate a player's point total. In some examples, in the case of a tie, the winner may be the first player to reach the top point total. In some examples, a prize structure may include multiple configurable levels of prizes, e.g., a main prize and two levels of secondary prizes, for example.

In some examples, the tournament prize may be funded independently from the VLTs or other gaming devices, e.g., an operator's marketing budget. In some examples, the tournament may be funded by an entry fee, e.g., cash, credit, and/or points, etc., paid by each player to participate in the tournament. In some examples, entry fees may be modified and/or waived for certain players and/or player tiers, such as players with higher loyalty program statuses.

Slot tournaments may be an effective way of driving interest for a particular game or promotion in the casino space. However, such mechanisms may not be similarly available the VLT world for various reasons. In some embodiments, similar promotions may leverage the VLT industry to offer events. A casino may provide sufficient space to hold slot tournaments as a promotional opportunities for members, and/or to garner excitement for a new game. For example, since VLTs may be primarily located in smaller venues, bars and/or gaming houses, offering such event may present additional challenges in offering such events. As disclosed herein, VLTs may be connected to other VLTs involves connecting VLTs in multiple venues (both land-based and online) to allow for similar type tournaments to occur.

Offering multi-venue tournaments in the VLT space may prove to be an exciting revenue opportunity for VLT owners, operators and/or vendors, among others. In this manner, player engagement and excitement in local establishment may be increased by offering a multitude of prizes for participating. In some embodiments, tournaments may be free and/or pay to play and the winner(s) may receive a portion of the prize pool. In some embodiments, the winning establishment may receive the remainder. For example, consider a location with venues that could engage in competition to see which venue is the “best” by having linked tournaments amongst all locations at a given date and time.

In some embodiments, a tournament may provide that VLTs having the same venue type may be connected into the same tournament. In some embodiments, a specific online tournament room may be “owned” by a venue operator and may allow online tournament players to participate.

Some embodiments provide that a competition may be between venues in one or more geofenced areas. In some embodiments, geofenced tournaments may provide that tournaments between multiple tournaments may be play for bragging rates among different tournaments.

In some embodiments, a VLTs in an area may have a tournament mode that may be enabled by a back office of an operator. In some embodiments, an organization may pre-set values and/or specific machines to go into a tournament at a present time and/or date.

In some embodiments, an online portal that is specific venue's players may have dedicated online tournament space in which a player may participate in the tournament with one or more other physical players. Some embodiments provide that the venue owner may elect to make any tournament an online only, physical only and/or combination thereof.

In some embodiments, multiple venue owners may agree to have one or more VLTs within their venue at a certain date and time. The time and date may not correspond with the same time interval.

Some embodiments provide that the tournament may include staggered timing in which certain amount of time for a specific venue may be allowed within a given date/time requirement.

Some embodiments provide that players may be provided with a chooser screen with multiple options. Such options include that a selection of players across selected venues may be chosen in the chooser menu. In some embodiments, once enabled, the tournament mode may be enabled in the chooser menu.

Some embodiments provide that player registration may include a player being selected to play. Embodiments then may enter their name and venue location. The location may be automatically filled based on the location of the venue. In some embodiments, a player may have the option to register for the tournament based on satisfying one or more qualifications or criteria.

Once a player enters their name, they may be given a certain amount of time to play and bankroll as many games as possible. If the player has a bonus when the time expires then they may be permitted to finish that bonus to count towards their final score. The machine may then be locked and the player's final score may be tracked on the leaderboard.

Some embodiments provide that then the next player may then sign in and play their session. This pattern may continue for the duration of the tournament. Some embodiments provide that there may be one or more VLTs within in a venue that may be used.

Some embodiments provide that the more VLTs that are used, the greater chance that a winner could come from that venue. Winners may be determined within a single venue or amongst all locations participating in the tournament. Winners from a previous session may be invited back at a future date for a “tournament of champions” for a chance to wine larger prizes,

[symbol]

In some embodiments, venues may choose for players to pay to enter tournaments and be able to keep a portion of the entry fee and a balance of all funds can be used as prize payouts to top scorers.

In some embodiments, connectivity herein may allow the linking of multiple venues including physical venues within a specific geofenced area. Geofenced areas may be defined by geographical properties, political zones, governmental jurisdiction zones and/or culturally specifically zones or areas. Some embodiments provide that online players may be allowed within a specified online “room”) to join with physical online players in a tournament. In some embodiments, while within a specific venue players may connect via their mobile devices.

Some embodiments provide that players may have the option to switch their tournament device from one device and/or type thereof to another device and/or type thereof while in the tournament. In some embodiments, a player may be sitting at the bar playing the tournament on their phone while another player finishes their tournament play on a physical cabinet and leaves the cabinet. In such embodiments, a mobile device player can then switch over from their phone to the cabinet to complete their tournament session.

Some embodiments provide that invitations may be sent and/or caused to be sent to potential future players. Some embodiments provide that a player (e.g., person A) participating in a tournament that is being played on a physical cabinet may send an “invite” to a friend (e.g., person B) that is in the physical venue but not at cabinet. Some embodiments provide that Person A can send and/or cause to be sent an invite from their phone and/or directly from the cabinet to their friend in the venue. The invite may invite them to participate in a predefined geofenced area.

Some embodiments provide a phone proximity share feature that may allow connectivity and/or access credentials to allow a password or other credential to be shared with another player or invitee. Some embodiments may allow a player to invite a friend who is not at the venue to participate in the same upcoming tournament and/or tournament that is already in progress, assuming that there is staggered timing.

In some embodiments, a link and/or QR code may be shared. Some embodiments include invite rewards in which players can be rewarded for inviting friends and having them join a tournament. Specific tasks may be set up and players may be rewarded with further tournament entries by completing tasks. For example, a reward may be provided for inviting one mobile player and one online player to play. If they accept the invite and play in the tournament, all players may be rewarded. In some embodiments, further tournament entries, free play and/or other rewards may be provided.

In some embodiments, each tournament player may be given a specific number of invitations that they can use to distribute to friends. Such invites may only be available to be given to mobile players in the venue and/or online players playing online but not in the venue. In some embodiments, players who had participated in more tournaments would have incrementally more invites that they may be given to distribute. In some embodiments, high level and/or experienced players could stack their invites over multiple tournaments if they didn't use in current or previous tournaments.

In some embodiments, a player that has signed up for tournament play may receive location-based prompts if they are in a “tournament area”. Some embodiments provide that these may be notifications that a tournament will start soon in an area and/or that one is currently happening. The player may then choose to sign up and/or join that tournament. The player may also set a reminder message to notify and/or remind the player of upcoming tournaments. In some embodiments, players may set their tournament preferences. Tournament preference may include game type, tournament size, tournament day, and/or specialized notifications for tournaments, among others. Preferences may further note a play preference for to playing on via mobile device, online and/or venue, among others.

Some embodiments may include online tournament rooms that may allow for online tournament spaces that are “owned” by specific venues and/or by government lottery agencies. These rooms may have exclusive access based on registration and/or by invite from venues based on game play, among others. When hosting a tournament in a physical location or a combination of physical locations, the online room may be added as another location. Players logging in and playing from the online room may play the same game, with the same tournament conditions as the physical location players.

Some embodiments provide a feature in which online players participating in cross channel tournaments can be awarded additional items, such as free play, merchandise and/or future tournament entries, among others.

In some embodiments, cross venue leaderboard(s) and/or statistics may allow for venues and mobile devices to display different categories of a leaderboard. Examples of such categories may include a venue with the most participants, top tournament scorers per venue and from overall geofenced area, a venue with the most tournament winners over time, and/or individual player's statistics, among others. If applicable, the current prize pools and payouts for winners may be displayed. In some embodiments, leaderboards may be based on the device and/or type thereof used.

Some embodiments provide a player voting game selection that allows for players across all channels/locations to vote for which game to use for the tournaments. Voting may be open for a limited time leading up to the tournament day. Some embodiments may show voting statistics between online/physical/mobile players to show which segment voted for which game. In some embodiments, if a new game is about to be released in the market, that new game may be used for the tournament to “introduce it” to the players.

Some embodiments may provide in-tournament boosts. Some embodiments provide that if certain thresholds are met within a specific venue, then all players within that venue may get a tournament enhancement. For example, if there are at least X players participating within a certain venue, their tournament clock may be given an extra 30 seconds. In some embodiments, competitive boosts may be between venues. Whenever another person signs up for one of the venues, that venue may only get a time boost. A bonus boost may occur responsive to a given - amount of people in one group hits a bonus in their game play. Such embodiments may provide that all other venues get extended time play and/or an automatic bonus.

Some embodiments may allow players to see how many “friends” they have participating in a tournament across all channels. This may be provided as a real time counter on the screen. Having additional friends and/or a certain threshold of friends met may unlock a boost feature in terms of time and/or additional bonus play.

Some embodiments provide that tie breakers may be broken by the raw number of players checked in between the venues. Venue points may be multiplied by a factor based on number of participants within a specific venue. Some embodiments provide that player status can impact scoring as well. Venue points may be based on the number of players within a certain tier.

Some embodiments provide that there could be specialized tournaments in which players compete within their own venue, and then the winners/top X players from individual venue may compete in regional tournaments. In some embodiments, the winners of the regional tournaments may compete in provincial tournaments and may ultimately lead to a national and/or even world champion.

In some embodiments a cross-channel tournament based on a number of games and not time may be an option that would benefit players who may not have the time to play the tournament duration at a single sitting. If based on games played, a player could play some of their games at one time/location/device and their remaining games at a different time/location/device.

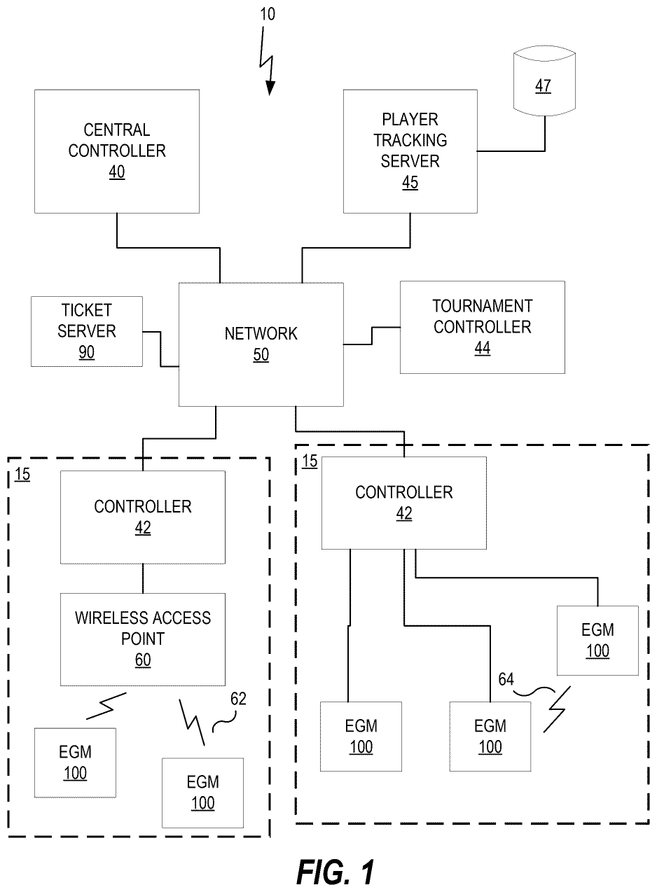

Before describing these and other features in greater detail, reference is now made to FIG. 1, which illustrates a gaming system 10 including a plurality of gaming devices 100 (which are EGMs in this embodiment). The gaming devices 100 may be one type of a variety of different types of gaming devices, such as electronic gaming machines (EGMs), video lottery terminals (VLTs), mobile gaming devices, or other devices, for example. The gaming system 10 may be located, for example, on the premises of a gaming establishment, such as a casino, and/or distributed across one or more different locations 15, such as a plurality of retailers or other establishments. The gaming devices 100 may be in communication with each other and/or at least one central controller 40 through a data communication network 50 that may include a remote communication link. The data communication network 50 may be a private data communication network that is operated, for example, by the gaming facility that operates the gaming devices 100. Communications over the data communication network 50 may be encrypted for security. Each location 15 may include a site controller 42 for managing communication with the central controller 40 and for controlling and managing the gaming devices 100. The central controller 40 and/or site controller 42 may be any suitable server or computing device which includes at least one processing circuit and at least one memory or storage device. Each gaming device 100 (which are EGMs in this example) may include a processing circuit that transmits and receives events, messages, commands or any other suitable data or signal between the gaming device 100, the site controller 42, and/or the central controller 40. The gaming device processing circuit is operable to execute such communicated events, messages or commands in conjunction with the operation of the gaming device 100. Moreover, the processing circuit of the and/or site controller 42 is configured to transmit and receive events, messages, commands or any other suitable data or signal between the central controller 40, the site controller 42, and/or each of the individual gaming devices 100. In some embodiments, one or more of the functions of the central controller 40 and/or site controller 42 may be performed by one or more gaming device processing circuits. Moreover, in some embodiments, one or more of the functions of one or more gaming device processing circuits as disclosed herein may be performed by the central controller 40 and/or site controller 42.

A wireless access point 60 provides wireless access to the data communication network 50. The wireless access point 60 may be connected to the data communication network 50 as illustrated in FIG. 1, and/or may be connected directly to the central controller 40 or another server connected to the data communication network 50.

A player tracking server 45 may also be connected through the data communication network 50. The player tracking server 45 may manage a player tracking account that tracks the player's gameplay and spending and/or other player preferences and customizations, manages loyalty awards for the player, manages funds deposited or advanced on behalf of the player, and other functions. Player information managed by the player tracking server 45 may be stored in a player information database 47.

As further illustrated in FIG. 1, the gaming system 10 may include a ticket server 90 that is configured to print and/or dispense wagering tickets. The ticket server 90 may be in communication with the central controller 40 and/or site controller 42 through the data communication network 50. The ticket server 90 may be located remotely from the individual locations 15 and/or site controllers 42 and/or may be located at individual locations 15 and/or proximate to individual site controllers 42. In some examples, the ticket server 90 and/or functions thereof may be integrated into the central controller 40 and/or local controllers 42. Each ticket server 90 may include a processing circuit that transmits and receives events, messages, commands or any other suitable data or signal between the ticket server 90 and the central controller 40 and/or local controller 42. The ticket server 90 processing circuit may be operable to execute such communicated events, messages or commands in conjunction with the operation of the ticket server 90. Moreover, in some embodiments, one or more of the functions of one or more ticket server 90 processing circuits as disclosed herein may be performed by the central controller 40 and/or local controller 42. In some embodiments, a tournament controller 44 may be in communication with the gaming devices 100 via one or more communication protocols.

The gaming devices 100 communicate with one or more elements of the gaming system 10 to coordinate providing wagering games and other functionality. For example, in some embodiments, the gaming device 100 may communicate directly with the ticket server 90 over a wireless interface 62, which may be a WiFi link, a Bluetooth link, a near field communications (NFC) link, etc. In other embodiments, the gaming device 100 may communicate with the data communication network 50 (and devices connected thereto, including other gaming devices 100) over a wireless interface 64 with the wireless access point 60. The wireless interface 64 may include a WiFi link, a Bluetooth link, an NFC link, etc. Some embodiments provide that gaming devices 100 may communicate with other gaming devices 100 or other system components over a wireless interface 64. In these embodiments, wireless interface 62, and wireless interface 64 may use different communication protocols and/or different communication resources, such as different frequencies, time slots, spreading codes, etc.

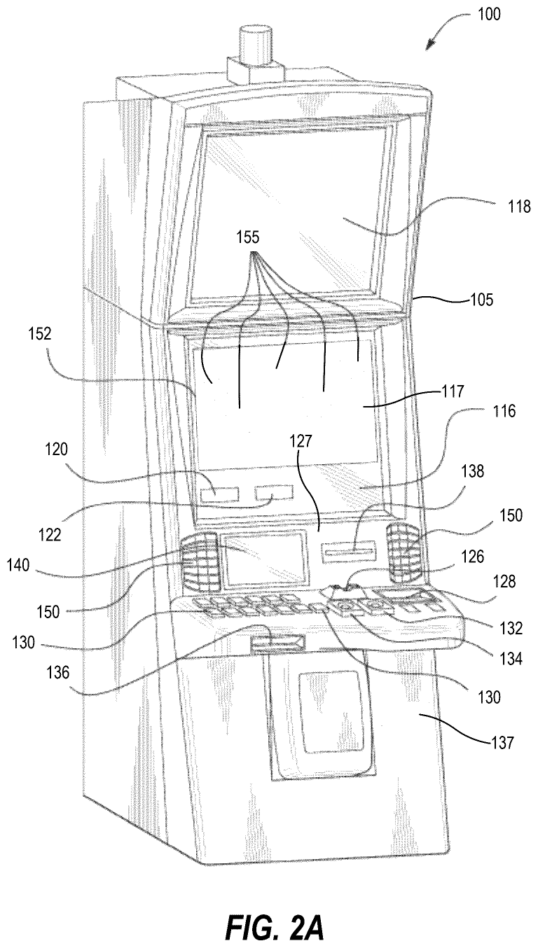

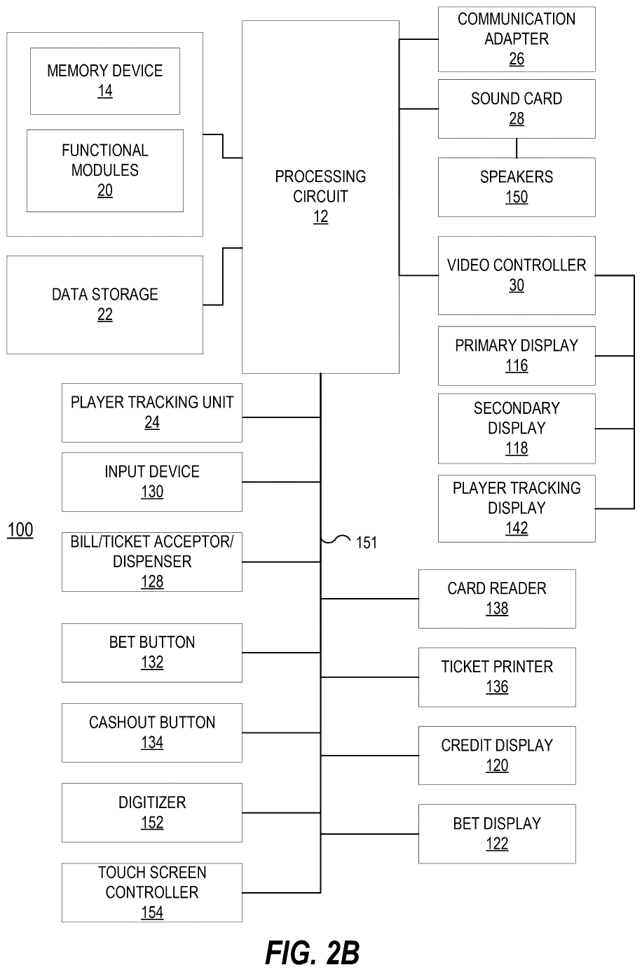

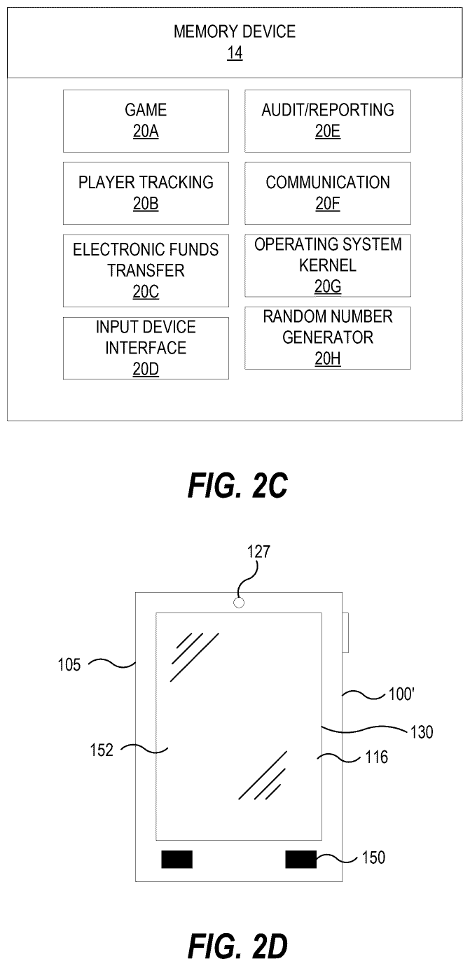

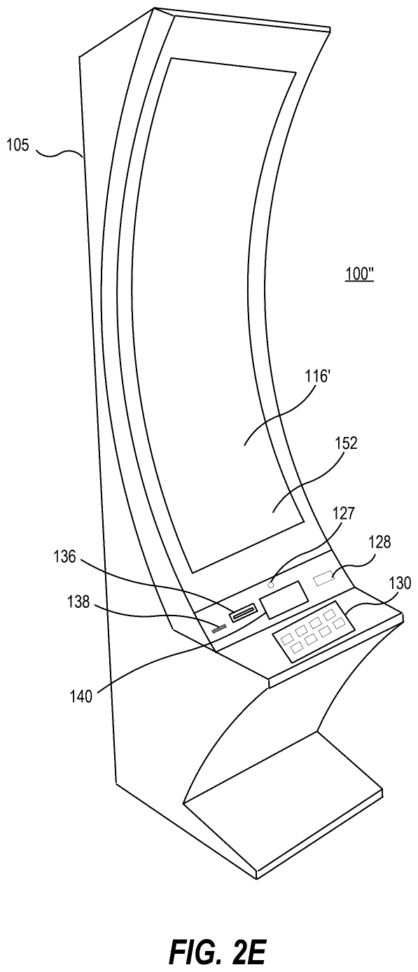

Embodiments herein may include different types of gaming devices. One example of a gaming device includes a gaming device 100 that can use gesture and/or touch-based inputs according to various embodiments is illustrated in FIGS. 2A, 2B, and 2C in which FIG. 2A is a perspective view of a gaming device 100 illustrating various physical features of the device, FIG. 2B is a functional block diagram that schematically illustrates an electronic relationship of various elements of the gaming device 100, and FIG. 2C illustrates various functional modules that can be stored in a memory device of the gaming device 100. The embodiments shown in FIGS. 2A to 2C are provided as examples for illustrative purposes only. It will be appreciated that gaming devices may come in many different shapes, sizes, layouts, form factors, and configurations, and with varying numbers and types of input and output devices, and that embodiments are not limited to the particular gaming device structures described herein.

Gaming devices 100 typically include a number of standard features, many of which are illustrated in FIGS. 2A and 2B. For example, referring to FIG. 2A, a gaming device 100 (which is an EGM 160 in this embodiment) may include a support structure, housing 105 (e.g., cabinet) which provides support for a plurality of displays, inputs, outputs, controls and other features that enable a player to interact with the gaming device 100.

The gaming device 100 illustrated in FIG. 2A includes a number of display devices, including a primary display device 116 located in a central portion of the housing 105 and a secondary display device 118 located in an upper portion of the housing 105. A plurality of game components 155 are displayed on a display screen 117 of the primary display device 116. It will be appreciated that one or more of the display devices 116, 118 may be omitted, or that the display devices 116, 118 may be combined into a single display device. The gaming device 100 may further include a player tracking display 142, a credit display 120, and a bet display 122. The credit display 120 displays a player's current number of credits, cash, account balance or the equivalent. The bet display 122 displays a player's amount wagered. Locations of these displays are merely illustrative as any of these displays may be located anywhere on the gaming device 100.

The player tracking display 142 may be used to display a service window that allows the player to interact with, for example, their player loyalty account to obtain features, bonuses, comps, etc. In other embodiments, additional display screens may be provided beyond those illustrated in FIG. 2A. In some embodiments, one or more of the player tracking display 142, the credit display 120 and the bet display 122 may be displayed in one or more portions of one or more other displays that display other game related visual content. For example, one or more of the player tracking display 142, the credit display 120 and the bet display 122 may be displayed in a picture in a picture on one or more displays.

The gaming device 100 may further include a number of input devices 130 that allow a player to provide various inputs to the gaming device 100, either before, during or after a game has been played. The gaming device may further include a game play initiation button 132 and a cashout button 134. The cashout button 134 is utilized to receive a cash payment or any other suitable form of payment corresponding to a quantity of remaining credits of a credit display.

In some embodiments, one or more input devices of the gaming device 100 are one or more game play activation devices that are each used to initiate a play of a game on the gaming device 100 or a sequence of events associated with the gaming device 100 following appropriate funding of the gaming device 100. The example gaming device 100 illustrated in FIGS. 2A and 2B includes a game play activation device in the form of a game play initiation button 132. It should be appreciated that, in other embodiments, the gaming device 100 begins game play automatically upon appropriate funding rather than upon utilization of the game play activation device.

In some embodiments, one or more input device 130 of the gaming device 100 may include wagering or betting functionality. For example, a maximum wagering or betting function may be provided that, when utilized, causes a maximum wager to be placed. Another such wagering or betting function is a repeat the bet device that, when utilized, causes the previously placed wager to be placed. A further such wagering or betting function is a bet one function. A bet is placed upon utilization of the bet one function. The bet is increased by one credit each time the bet one device is utilized. Upon the utilization of the bet one function, a quantity of credits shown in a credit display (as described below) decreases by one, and a number of credits shown in a bet display (as described below) increases by one.

In some embodiments, as shown in FIG. 2B, the input device(s) 130 may include and/or interact with additional components, such as gesture sensors 156 for gesture input devices, and/or a touch-sensitive display that includes a digitizer 152 and a touchscreen controller 154 for touch input devices, as disclosed herein. The player may interact with the gaming device 100 by touching virtual buttons on one or more of the display devices 116, 118, 140. Accordingly, any of the above-described input devices, such as the input device 130, the game play initiation button 132 and/or the cashout button 134 may be provided as virtual buttons or regions on one or more of the display devices 116, 118, 140.

Referring briefly to FIG. 2B, operation of the primary display device 116, the secondary display device 118 and the player tracking display 142 may be controlled by a video controller 30 that receives video data from a processing circuit 12 or directly from a memory device 14 and displays the video data on the display screen. The credit display 120 and the bet display 122 are typically implemented as simple liquid crystal display (LCD) or light emitting diode (LED) displays that display a number of credits available for wagering and a number of credits being wagered on a particular game. Accordingly, the credit display 120 and the bet display 122 may be driven directly by the processing circuit 12. In some embodiments however, the credit display 120 and/or the bet display 122 may be driven by the video controller 30.

Referring again to FIG. 2A, the display devices 116, 118, 140 may include, without limitation: a cathode ray tube, a plasma display, an LCD, a display based on LEDs, a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In certain embodiments, as described above, the display devices 116, 118, 140 may include a touchscreen with an associated touchscreen controller 154 and digitizer 152. The display devices 116, 118, 140 may be of any suitable size, shape, and/or configuration. The display devices 116, 118, 140 may include flat or curved display surfaces.

The display devices 116, 118, 140 and video controller 30 of the gaming device 100 are generally configured to display one or more game and/or non-game images, symbols, and indicia. In certain embodiments, the display devices 116, 118, 140 of the gaming device 100 are configured to display any suitable visual representation or exhibition of the movement of objects; dynamic lighting; video images; images of people, characters, places, things, and faces of cards; and the like. In certain embodiments, the display devices 116, 118, 140 of the gaming device 100 are configured to display one or more virtual reels, one or more virtual wheels, and/or one or more virtual dice. In other embodiments, certain of the displayed images, symbols, and indicia are in mechanical form. That is, in these embodiments, the display device 116, 118, 140 includes any electromechanical device, such as one or more rotatable wheels, one or more reels, and/or one or more dice, configured to display at least one or a plurality of game or other suitable images, symbols, or indicia.

The gaming device 100 also includes various features that enable a player to deposit credits in the gaming device 100 and withdraw credits from the gaming device 100, such as in the form of a payout of winnings, credits, etc. For example, the gaming device 100 may include a bill/ticket dispenser 136, a bill/ticket acceptor 128, and a coin acceptor 126 that allows the player to deposit coins into the gaming device 100.

As illustrated in FIG. 2A, the gaming device 100 may also include a currency dispenser 137 that may include a note dispenser configured to dispense paper currency and/or a coin generator configured to dispense coins or tokens in a coin payout tray.

The gaming device 100 may further include one or more speakers 150 controlled by one or more sound cards 28 (FIG. 2B). The gaming device 100 illustrated in FIG. 2A includes a pair of speakers 150. In other embodiments, additional speakers, such as surround sound speakers, may be provided within or on the housing 105. Moreover, the gaming device 100 may include built-in seating with integrated headrest speakers.

In various embodiments, the gaming device 100 may generate dynamic sounds coupled with attractive multimedia images displayed on one or more of the display devices 116, 118, 140 to provide an audio-visual representation or to otherwise display full-motion video with sound to attract players to the gaming device 100 and/or to engage the player during gameplay. In certain embodiments, the gaming device 100 may display a sequence of audio and/or visual attraction messages during idle periods to attract potential players to the gaming device 100. The videos may be customized to provide any appropriate information.

The gaming device 100 may further include a card reader 138 that is configured to read magnetic stripe cards, such as player loyalty/tracking cards, chip cards, and the like. In some embodiments, a player may insert an identification card into a card reader of the gaming device. In some embodiments, the identification card is a smart card having a programmed microchip or a magnetic strip coded with a player's identification, credit totals (or related data) and other relevant information. In other embodiments, a player may carry a portable device, such as a cell phone, a radio frequency identification tag or any other suitable wireless device, which communicates a player's identification, credit totals (or related data) and other relevant information to the gaming device. In some embodiments, money may be transferred to a gaming device through electronic funds transfer. When a player funds the gaming device, the processing circuit determines the amount of funds entered and displays the corresponding amount on the credit or other suitable display as described above.

In some embodiments, the gaming device 100 may include an electronic payout device or module configured to fund an electronically recordable identification card or smart card or a bank or other account via an electronic funds transfer to or from the gaming device 100.

FIG. 2B is a block diagram that illustrates logical and functional relationships between various components of a gaming device 100. It should also be understood that components described in FIG. 2B may also be used in other computing devices, as desired, such as mobile computing devices for example. As shown in FIG. 2B, the gaming device 100 may include a processing circuit 12 that controls operations of the gaming device 100. Although illustrated as a single processing circuit, multiple special purpose and/or general-purpose processors and/or processor cores may be provided in the gaming device 100. For example, the gaming device 100 may include one or more of a video processor, a signal processor, a sound processor and/or a communication controller that performs one or more control functions within the gaming device 100. The processing circuit 12 may be variously referred to as a “controller,” “microcontroller,” “microprocessor” or simply a “computer.” The processor may further include one or more application-specific integrated circuits (ASICs).

Various components of the gaming device 100 are illustrated in FIG. 2B as being connected to the processing circuit 12. It will be appreciated that the components may be connected to the processing circuit 12 through a system bus 151, a communication bus and controller, such as a universal serial bus (USB) controller and USB bus, a network interface, or any other suitable type of connection.

The gaming device 100 further includes a memory device 14 that stores one or more functional modules 20. Various functional modules 20 of the gaming device 100 will be described in more detail below in connection with FIG. 2D.

The memory device 14 may store program code and instructions, executable by the processing circuit 12, to control the gaming device 100. The memory device 14 may also store other data such as image data, event data, player input data, random or pseudo-random number generators, pay-table data or information and applicable game rules that relate to the play of the gaming device. The memory device 14 may include random access memory (RAM), which can include non-volatile RAM (NVRAM), magnetic RAM (ARAM), ferroelectric RAM (FeRAM) and other forms as commonly understood in the gaming industry. In some embodiments, the memory device 14 may include read only memory (ROM). In some embodiments, the memory device 14 may include flash memory and/or EEPROM (electrically erasable programmable read only memory). Any other suitable magnetic, optical and/or semiconductor memory may operate in conjunction with the gaming device disclosed herein.

The gaming device 100 may further include a data storage 22, such as a hard disk drive or flash memory. The data storage 22 may store program data, player data, audit trail data or any other type of data. The data storage 22 may include a detachable or removable memory device, including, but not limited to, a suitable cartridge, disk, CD ROM, Digital Video Disc (“DVD”) or USB memory device.

The gaming device 100 may include a communication adapter 26 that enables the gaming device 100 to communicate with remote devices over a wired and/or wireless communication network, such as a local area network (LAN), wide area network (WAN), cellular communication network, or other data communication network. The communication adapter 26 may further include circuitry for supporting short range wireless communication protocols, such as Bluetooth and/or NFC that enable the gaming device 100 to communicate, for example, with a mobile communication device operated by a player.

The gaming device 100 may include one or more internal or external communication ports that enable the processing circuit 12 to communicate with and to operate with internal or external peripheral devices, such as eye tracking devices, position tracking devices, cameras, accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, Small Computer System Interface (“SCSI”) ports, solenoids, speakers, thumb drives, ticket readers, touch screens, trackballs, touchpads, wheels, and wireless communication devices. In some embodiments, internal or external peripheral devices may communicate with the processing circuit through a USB hub (not shown) connected to the processing circuit 12.

In some embodiments, the gaming device 100 may include a sensor, such as a camera 127, in communication with the processing circuit 12 (and possibly controlled by the processing circuit 12) that is selectively positioned to acquire an image of a player actively using the gaming device 100 and/or the surrounding area of the gaming device 100. In one embodiment, the camera 127 may be configured to selectively acquire still or moving (e.g., video) images and may be configured to acquire the images in either an analog, digital or other suitable format. The display devices 116, 118, 140 may be configured to display the image acquired by the camera 127 as well as display the visible manifestation of the game in split screen or picture-in-picture fashion. For example, the camera 127 may acquire an image of the player and the processing circuit 12 may incorporate that image into the primary and/or secondary game as a game image, symbol or indicia.

Various functional modules of that may be stored in a memory device 14 of a gaming device 100 are illustrated in FIG. 2C. Referring to FIG. 2C, the gaming device 100 may include in the memory device 14 a game module 20A that includes program instructions and/or data for operating a hybrid wagering game as described herein. The gaming device 100 may further include a player tracking module 20B, an electronic funds transfer module 20C, an input device interface 20D, an audit/reporting module 20E, a communication module 20F, an operating system kernel 20G and a random number generator 20H. The player tracking module 20B keeps track of the play of a player. The electronic funds transfer module 20C communicates with a back-end server or financial institution to transfer funds to and from an account associated with the player. The input device interface 20D interacts with input devices, such as the input device 130, as described in more detail below. The communication module 20F enables the gaming device 100 to communicate with remote servers and other gaming devices using various secure communication interfaces. The operating system kernel 20G controls the overall operation of the gaming device 100, including the loading and operation of other modules. The random number generator 20H generates random or pseudorandom numbers for use in the operation of the hybrid games described herein.

In some embodiments, a gaming device 100 includes a personal device, such as a desktop computer, a laptop computer, a mobile device, a tablet computer or computing device, a personal digital assistant (PDA), or other portable computing devices. In some embodiments, the gaming device 100 may be operable over a wireless network, such as part of a wireless gaming system. In such embodiments, the gaming machine may be a hand-held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission.

For example, referring to FIG. 2D, a gaming device 100 (which is a mobile gaming device 170 in this embodiment) may be implemented as a handheld device including a compact housing 105 on which is mounted a touchscreen display device 116 including a digitizer 152. One or more input devices 130 may be included for providing functionality of for embodiments described herein. A camera 127 may be provided in a front face of the housing 105. The housing 105 may include one or more speakers 150. In the gaming device 100, various input buttons described above, such as the cashout button, gameplay activation button, etc., may be implemented as soft buttons on the touchscreen display device 116 and/or input device 130. In this embodiment, the input device 130 is integrated into the touchscreen display device 116, but it should be understood that the input device may also, or alternatively, be separate from the display device 116. Moreover, the gaming device 100 may omit certain features, such as a bill acceptor, a ticket generator, a coin acceptor or dispenser, a card reader, secondary displays, a bet display, a credit display, etc. Credits can be deposited in or transferred from the gaming device 100 electronically.

FIG. 2E illustrates a standalone gaming device 100 (which is an EGM 160 in this embodiment) having a different form factor from the EGM 160 illustrated in FIG. 2A. In particular, the gaming device 100 is characterized by having a large, high aspect ratio, curved primary display device 116 provided in the housing 105, with no secondary display device. The primary display device 116 may include a digitizer 152 to allow touchscreen interaction with the primary display device 116. The gaming device 100 may further include a player tracking display 142, an input device 130, a bill/ticket acceptor 128, a card reader 138, and a bill/ticket dispenser 136. The gaming device 100 may further include one or more cameras 127 to enable facial recognition and/or motion tracking.

Embodiments herein may include different types of gaming devices.

Many embodiments described herein employ gaming devices 100 that are land-based EGMs, such as banks of slot machines in a casino environment, but in some embodiments, a gaming device 100 may additionally or alternatively include a personal device, such as a desktop computer, a laptop computer, a mobile device, a tablet computer or computing device, a personal digital assistant (PDA), or other portable computing devices. In some embodiments, the gaming device 100 may be operable over a wireless network, such as part of a wireless gaming system. In such embodiments, the gaming machine may be a hand-held device, a mobile device or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission.

Although illustrated as certain gaming devices, such as EGMs, VLTs, and mobile gaming devices, functions and/or operations as described herein may also include wagering stations that may include electronic game tables, conventional game tables including those involving cards, dice and/or roulette, and/or other wagering stations such as sports book stations, video poker games, skill-based games, virtual casino-style table games, or other casino, lottery, or other style games. Further, gaming devices according to embodiments herein may be implemented using other computing devices and mobile devices, such as smart phones, tablets, and/or personal computers, among others.

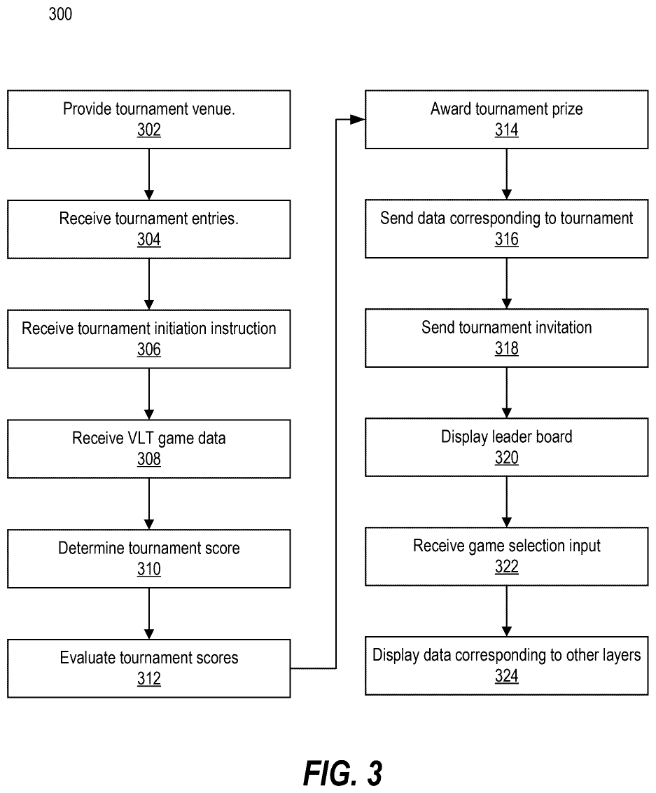

Reference is now made to FIG. 3, which is a flowchart illustrating operations of systems/methods of providing multiple venue/channel video lottery tournaments, according to some embodiments. A system includes a processor circuit and a memory including machine-readable instructions that, when executed by the processor circuit, cause the processor circuit to provide (block 302) a tournament venue for a wagering game tournament to be played. The processor circuit is further caused to receive (block 304) multiple tournament entries from multiple players for the wagering game tournament. For some of the tournament entries, the processor circuit is caused to receive (block 306) a tournament initiation instruction from one of the players at a video lottery tournament (VLT) gaming device and receive (block 308) VLT game data for a base wagering game from the VLT gaming device during the wagering game tournament. The processor circuit is further caused to determine (block 310) a tournament score for the players in the tournament venue based on play data and a tournament parameter and to evaluate (block 312) multiple tournament scores for the players and to award (block 314) a tournament prize to one of the players based on an evaluation of the tournament scores corresponding to the wagering game tournament.

In some embodiments, the tournament venue includes a physical venue that includes a defined geofenced area. Some embodiments provide that a defined geofenced area includes a geographically defined area.

In some embodiments, the players include multiple online players and a physically present player. In some embodiments, one of the online players is allowed to join the physically present player in the wagering game tournament. In some embodiments, one of the online players includes a mobile device user that participates in the wagering game tournament via a wireless mobile device.

In some embodiments, the VLT gaming device includes a first VLT gaming device that includes a first type of VLT gaming device and a second VLT gaming device that includes a second type of VLT gaming device. Some embodiments provide that the first type of VLT gaming device is different than the second type of VLT gaming device. In some embodiments, and in response to a device switch signal provided by one of the multiple players, the wagering game tournament is switched from the first VLT gaming device to the second VLT gaming device during tournament play.

In some embodiments, the VLT gaming device includes a first VLT gaming device that includes a first type of VLT gaming device and a second VLT gaming device that includes a second type of VLT gaming device. In some embodiments, the first type of VLT gaming device is different than the second type of VLT gaming device and the wagering game tournament is started on the first type of VLT gaming device and ends on the second type VLT gaming device.

Some embodiments provide that receiving the tournament initiation instruction causes the processor circuit to send an invitation to play in an upcoming tournament to include another player that is not in the tournament venue. In some embodiments, the invitation to play in the upcoming tournament includes a sharable link that includes data corresponding to participating in the upcoming tournament.

In some embodiments, the processor circuit is further caused to send (block 316), to ones of the players, data corresponding to the wagering game tournament and, responsive to wagering game performance of ones of the players, provide each of the players with another tournament entry.

Some embodiments provide that the players include a first portion of players and a second portion of players. The first portion of players includes players playing in a first tournament venue and the second portion of players includes players playing in a second tournament venue. The first portion of players competes against the second portion of players in the wagering game tournament.

In some embodiments, in response to invitations that are sent and not accepted, the processor circuit is caused to store unused invitations for use in a future tournament.

Some embodiments provide that, in response to invitations that are not sent, the processor circuit is caused to incrementally increase a quantity of invitations to one of the players in subsequent wagering game tournaments.

In some embodiments, in response to one of the players being in an area that corresponds to a location-based tournament, the processor circuit is further caused to send (block 318) a tournament invitation to the one of the players to notify that the wagering game tournament will begin. In some embodiments, the tournament invitation is location based.

Some embodiments provide that the tournament venue includes multiple tournament venues and that some of the tournament venues include a first portion of tournament venues that are associated with an operator entity and a second portion of tournament venues that are not associated with the operator entity.

In some embodiments, the tournament venue includes multiple tournament venues. Some embodiments, ones of the tournament venues include a first tournament venue and a second tournament venue. In some embodiments, the processor circuit is caused to display (block 320) a leader board that includes tournament performance data for ones of the tournament venues. Some embodiments provide that the first tournament venue includes a first channel of a tournament and the second tournament venue includes a second channel of the tournament.

In some embodiments, the processor circuit is further caused to receive (block 322) a game selection input that corresponds to which game a player of the players favors relative to other games.

In some embodiments, the processor circuit is further caused to display (block 324), to one of the players, data corresponding to a quantity of other players that are associated with the one of the plurality of players.

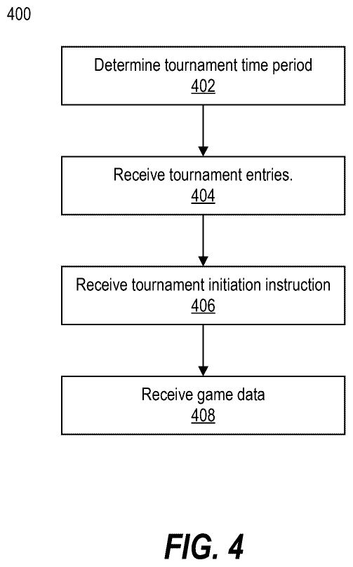

Brief reference is now made to FIG. 4, which is a flowchart illustrating operations of systems/methods of providing multiple venue/channel video lottery tournaments, according to some embodiments. A tournament controller according to some embodiments includes a communication interface in communication with multiple gaming devices, a processor circuit and a memory including machine-readable instructions that, when executed by the processor circuit, cause the processor circuit to perform operations described herein. The processor circuit may be operative to determine (block 402) a tournament time period for a wagering game tournament, receive (block 404), via the communication interface, multiple tournament entries from the gaming devices during the tournament time period. Each tournament entry of the multiple tournament entries is associated with a player.

Each tournament entry is operative to receive (block 406), via the communication interface, a tournament initiation instruction from a gaming device of the gaming devices and to receive (block 408), via the communication interface, game play data from the gaming device of the gaming devices for a base wagering game being played by the player at the gaming device during the wagering game tournament and that is determined to be played for a given quantity of spins.

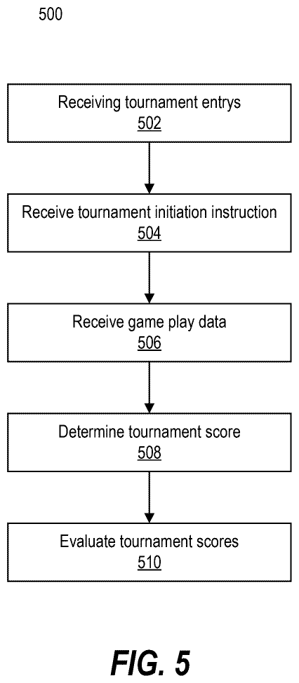

Brief reference is now made to FIG. 5, which is a flowchart illustrating operations of systems/methods of providing multiple venue/channel video lottery tournaments, according to some embodiments. Methods disclosed herein may perform operations of determining (block 502), by a processor circuit, a tournament time period for a wagering game tournament and that includes multiple of tournament start times for different ones of multiple players and receiving (block 504), by the processor circuit, multiple tournament entries from multiple video lottery tournament (VLT) gaming devices during the tournament time period. In some embodiments, each tournament entry of tournament entries is associated with one of the players. Operations may provide, for each tournament entry, receiving (block 506), by the processor circuit, a tournament initiation instruction from the VLT gaming device of the VLT gaming devices, receiving, by the processor circuit, game play data from the gaming device of the plurality of VLT gaming devices for a base wagering game being played by the player at the gaming device during the tournament time period. Operations include determining (block 508), by the processor circuit, a tournament score for the player associated with the gaming device based on play data and a tournament parameter and evaluating (block 510), by the processor circuit, multiple tournament scores for the players. Some embodiments provide that the game play data for the base wagering game is generated by each gaming device independently of the tournament parameter.

Embodiments described herein may be implemented in various configurations for gaming devices 100, including but not limited to: (1) a dedicated gaming device, wherein the computerized instructions for controlling any games (which are provided by the gaming device) are provided with the gaming device prior to delivery to a gaming establishment; and (2) a changeable gaming device, where the computerized instructions for controlling any games (which are provided by the gaming device) are downloadable to the gaming device through a data network when the gaming device is in a gaming establishment. In some embodiments, the computerized instructions for controlling any games are executed by at least one central server, central controller or remote host. In such a “thin client” embodiment, the central server remotely controls any games (or other suitable interfaces), and the gaming device is utilized to display such games (or suitable interfaces) and receive one or more inputs or commands from a player. In another embodiment, the computerized instructions for controlling any games are communicated from the central server, central controller or remote host to a gaming device local processor and memory devices. In such a “thick client” embodiment, the gaming device local processor executes the communicated computerized instructions to control any games (or other suitable interfaces) provided to a player.

In some embodiments, a gaming device may be operated by a mobile device, such as a mobile telephone, tablet or other mobile computing device. For example, a mobile device may be communicatively coupled to a gaming device and may include a user interface that receives user inputs that are received to control the gaming device. The user inputs may be received by the gaming device via the mobile device.

In some embodiments, one or more gaming devices in a gaming system may be thin client gaming devices and one or more gaming devices in the gaming system may be thick client gaming devices. In another embodiment, certain functions of the gaming device are implemented in a thin client environment and certain other functions of the gaming device are implemented in a thick client environment. In one such embodiment, computerized instructions for controlling any primary games are communicated from the central server to the gaming device in a thick client configuration and computerized instructions for controlling any secondary games or bonus functions are executed by a central server in a thin client configuration.

The present disclosure contemplates a variety of different gaming systems each having one or more of a plurality of different features, attributes, or characteristics. It should be appreciated that a “gaming system” as used herein refers to various configurations of: (a) one or more central servers, central controllers, or remote hosts; (b) one or more gaming devices; and/or (c) one or more personal gaming devices, such as desktop computers, laptop computers, tablet computers or computing devices, PDAs, mobile telephones such as smart phones, and other mobile computing devices.

In certain such embodiments, computerized instructions for controlling any games (such as any primary or base games and/or any secondary or bonus games) displayed by the gaming device are executed by the central server, central controller, or remote host. In such “thin client” embodiments, the central server, central controller, or remote host remotely controls any games (or other suitable interfaces) displayed by the gaming device, and the gaming device is utilized to display such games (or suitable interfaces) and to receive one or more inputs or commands. In other such embodiments, computerized instructions for controlling any games displayed by the gaming device are communicated from the central server, central controller, or remote host to the gaming device and are stored in at least one memory device of the gaming device. In such “thick client” embodiments, the at least one processor of the gaming device executes the computerized instructions to control any games (or other suitable interfaces) displayed by the gaming device.

In some embodiments in which the gaming system includes: (a) a gaming device configured to communicate with a central server, central controller, or remote host through a data network; and/or (b) a plurality of gaming devices configured to communicate with one another through a data network, the data network is an internet or an intranet. In certain such embodiments, an internet browser of the gaming device is usable to access an internet game page from any location where an internet connection is available. In one such embodiment, after the internet game page is accessed, the central server, central controller, or remote host identifies a player prior to enabling that player to place any wagers on any plays of any wagering games. In one example, the central server, central controller, or remote host identifies the player by requiring a player account of the player to be logged into via an input of a unique username and password combination assigned to the player. It should be appreciated, however, that the central server, central controller, or remote host may identify the player in any other suitable manner, such as by validating a player tracking identification number associated with the player; by reading a player tracking card or other smart card inserted into a card reader (as described below); by validating a unique player identification number associated with the player by the central server, central controller, or remote host; or by identifying the gaming device, such as by identifying the MAC address or the IP address of the internet facilitator. In various embodiments, once the central server, central controller, or remote host identifies the player, the central server, central controller, or remote host enables placement of one or more wagers on one or more plays of one or more primary or base games and/or one or more secondary or bonus games and displays those plays via the internet browser of the gaming device.

It should be appreciated that the central server, central controller, or remote host and the gaming device are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium. It should be appreciated that the expansion in the quantity of computing devices and the quantity and speed of internet connections in recent years increases opportunities for players to use a variety of gaming devices to play games from an ever-increasing quantity of remote sites. It should also be appreciated that the enhanced bandwidth of digital wireless communications may render such technology suitable for some or all communications, particularly if such communications are encrypted. Higher data transmission speeds may be useful for enhancing the sophistication and response of the display and interaction with players.

In some embodiments herein, display devices and/or displays may provide a graphical user interface that may receive input data and/or may display data for one or more users to receive. Some embodiments provide that the graphical user interface may display visual elements that may include symbols, icons, and/or static elements that may be positioned and/or move based on system and/or device data. Some embodiments provide that a processor as provided herein may automatically cause a visual element on the graphical user interface to move, change, or evolve. For example, when a displayed visual element such as an icon is automatically moved, the claim integrates any corresponding mental process into a practical application.

Specifically, embodiments described herein provide elements that recite a specific manner of automatically displaying visual elements, such as icons. Usage as described herein provides improvement over prior systems resulting in an improved user interface for electronic devices.

In the above description of various embodiments, various aspects may be illustrated and described herein in any of a number of patentable classes or contexts including any new and useful process, machine, manufacture, or composition of matter, or any new and useful improvement thereof. Accordingly, various embodiments described herein may be implemented entirely by hardware, entirely by software (including firmware, resident software, micro-code, etc.) or by combining software and hardware implementation that may all generally be referred to herein as a “circuit,” “module,” “component,” or “system.” Furthermore, various embodiments described herein may take the form of a computer program product including one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, radio frequency (“RF”), etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, Common Business Oriented Language (“COBOL”) 2002, PHP: Hypertext Processor (“PHP”), Advanced Business Application Programming (“ABAP”), dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Various embodiments were described herein with reference to flowchart illustrations and/or block diagrams of methods, apparatus (systems), devices and computer program products according to various embodiments described herein. It will be understood that each block of the flowchart illustrations and/or block diagrams, and combinations of blocks in the flowchart illustrations and/or block diagrams, can be implemented by computer program instructions. These computer program instructions may be provided to a processing circuit of a general purpose computer, special purpose computer, or other programmable data processing apparatus to produce a machine, such that the instructions, which execute via the processing circuit of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operations to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

What is claimed is:

1. A system comprising:
a processor circuit; and
a memory comprising machine-readable instructions that, when executed by the processor circuit, cause the processor circuit to:
provide a tournament venue for a wagering game tournament to be played;
receive a plurality of tournament entries from a plurality of players for the wagering game tournament;
for ones of the plurality of each of the plurality of tournament entries:
receive a tournament initiation instruction from one of the plurality of players at a video lottery tournament (VLT) gaming device;
receive VLT game data for a base wagering game from the VLT gaming device during the wagering game tournament; and
determine a tournament score for the plurality of players in the tournament venue based on play data and a tournament parameter;
evaluate a plurality tournament scores for the plurality of players; and
award a tournament prize to a player of the plurality of players based on an evaluation of the tournament scores corresponding to the wagering game tournament.

2. The system of claim 1, wherein the tournament venue comprises a physical venue that comprises a defined geofenced area.

3. The system of claim 2, wherein a defined geofenced area comprises a geographically defined area.

4. The system of claim 1, wherein the plurality of players comprises a plurality of online players and a physically present player, and wherein one of the plurality of online players is allowed to join the physically present player in the wagering game tournament.

5. The system of claim 4, wherein the one of the plurality of online players comprises a mobile device user that participates in the wagering game tournament via a wireless mobile device.

6. The system of claim 1, wherein the VLT gaming device comprises a first VLT gaming device that comprises a first type of VLT gaming device and a second VLT gaming device that comprises a second type of VLT gaming device,
wherein the first type of VLT gaming device is different than the second type of VLT gaming device, and
wherein, in response to a device switch signal provided by a player of the plurality of players, the wagering game tournament is switched from the first VLT gaming device to the second VLT gaming device during tournament play.

7. The system of claim 1, wherein the VLT gaming device comprises a first VLT gaming device that comprises a first type of VLT gaming device and a second VLT gaming device that comprises a second type of VLT gaming device,
wherein the first type of VLT gaming device is different than the second type of VLT gaming device, and
wherein, the wagering game tournament is started on the first type of VLT gaming device and ends on the second type VLT gaming device.

8. The system of claim 1, wherein receiving the tournament initiation instruction causes the processor circuit to send an invitation to play in an upcoming tournament to comprise another player that is not in the tournament venue.

9. The system of claim 8, wherein the invitation to play in the upcoming tournament comprises a sharable link that comprises data corresponding to participating in the upcoming tournament.

10. The system of claim 1, wherein the processor circuit is further caused to:
send, to ones of the plurality of players, data corresponding to the wagering game tournament; and
responsive to wagering game performance of ones of the plurality of players, provide each of the plurality of players with another tournament entry.

11. The system of claim 1,
wherein the plurality of players comprises a first portion of players and a second portion of players,
wherein the first portion of players comprise players playing in a first tournament venue and the second portion of players comprises players playing in a second tournament venue, and
wherein the first portion of players competes against the second portion of players in the wagering game tournament.

12. The system of claim 1, wherein, in response to invitations that are sent and not accepted, the processor circuit is caused to store unused invitations for use in a future tournament.

13. The system of claim 1, wherein, in response to invitations that are not sent, the processor circuit is caused to incrementally increase a quantity of invitations to one of the plurality of players in subsequent wagering game tournaments.

14. The system of claim 1, wherein in response to one of the plurality of players being in an area that corresponds to a location-based tournament, the processor circuit is further caused to send a tournament invitation to the one of the plurality of players to notify that the wagering game tournament will begin,
wherein the tournament invitation is location based.

15. The system of claim 1, wherein the tournament venue comprises a plurality of tournament venues, wherein ones of the plurality of tournament venues comprise a first portion of tournament venues that are associated with an operator entity and a second portion of tournament venues that are not associated with the operator entity.

16. The system of claim 1, wherein the tournament venue comprises a plurality of tournament venues, wherein ones of the plurality of tournament venues comprise a first tournament venue and a second tournament venue, wherein the processor circuit is caused to display a leader board that comprises tournament performance data for ones of the plurality of tournament venues, wherein the first tournament venue comprises a first channel of a tournament and the second tournament venue comprises a second channel of the tournament.

17. The system of claim 1, wherein the processor circuit is further caused to receive a game selection input that corresponds to which game a player of the plurality of players favors relative to other games.

18. The system of claim 1, wherein the processor circuit is further caused to display, to one of the plurality of players, data corresponding to a quantity of other ones of the plurality of players that are associated with the one of the plurality of players.

19. A tournament controller comprising:
a communication interface in communication with a plurality of gaming devices;
a processor circuit; and
a memory comprising machine-readable instructions that, when executed by the processor circuit, cause the processor circuit to:
determine a tournament time period for a wagering game tournament;
receive, via the communication interface, a plurality of tournament entries from the plurality of gaming devices during the tournament time period, each tournament entry of the plurality of tournament entries associated with a player;
for each tournament entry:
receive, via the communication interface, a tournament initiation instruction from a gaming device of the plurality of gaming devices; and
receive, via the communication interface, game play data from the gaming device of the plurality of gaming devices for a base wagering game being played by the player at the gaming device during the wagering game tournament and that is determined to be played for a given quantity of spins.

20. A method
A method comprising:
determining, by a processor circuit, a tournament time period for a wagering game tournament and that comprises a plurality of tournament start times for different ones of a plurality of players;
receiving, by the processor circuit, a plurality of tournament entries from a plurality of video lottery tournament (VLT) gaming devices during the tournament time period, each tournament entry of the plurality of tournament entries associated with one of the plurality of players;
for each tournament entry:
receiving, by the processor circuit, a tournament initiation instruction from the VLT gaming device of the plurality of VLT gaming devices;
receiving, by the processor circuit, game play data from the gaming device of the plurality of VLT gaming devices for a base wagering game being played by the player at the gaming device during the tournament time period; and
determining, by the processor circuit, a tournament score for the player associated with the gaming device based on play data and a tournament parameter; and
evaluating, by the processor circuit, a plurality of tournament scores for the plurality of players, wherein the game play data for the base wagering game is generated by each gaming device independently of the tournament parameter.
